(19) United States
(12) Patent Application Publication
(10) Pub. No.: US 2014/0149302 A1
(43) Pub. Date: May 29, 2014

(54) LIVE RESUME

(71) Applicants: Alejandro Zuccolillo, Sunny Isles, FL (US); Renato Zuccolillo, Sunny Isles, FL (US)

(72) Inventors: Alejandro Zuccolillo, Sunny Isles, FL (US); Renato Zuccolillo, Sunny Isles, FL (US)

(21) Appl. No.: 14/092,376

(22) Filed: Nov. 27, 2013

Related U.S. Application Data
(60) Provisional application No. 61/730,843, filed on Nov. 28, 2012.

(51) Int. Cl. G06Q 10/10

(52) U.S. Cl. CPC G06Q 10/1053
USPC 705/321

(57) ABSTRACT

A system and method of providing a live resume by a system is provided. The system is in communication with a service provider and the user has a user profile in the system. The method includes querying the service provider for user information relating to the user. The user information is received from the service provider. The received user information is grouped into predetermined categories. Attribute scores in the predetermined categories are determined based on the grouped user information. A matrix of the attribute scores of the user is provided. The matrix represents the live resume of the user.

### CROSS-REFERENCE TO RELATED APPLICATION

This application is related to and claims priority to U.S. Provisional Application Ser. No. 61/730,843, filed Nov. 28, 2013, entitled LIVE RESUME, the entirety of which is incorporated herein by reference.

### FIELD OF THE INVENTION

The present invention relates online user information, and more specifically to a method and system for providing verifiable and measurable student information.

### BACKGROUND OF THE INVENTION

About 52% of US employers recorded having difficulties finding talent for hiring, while 50% of college graduates have difficulties finding an appropriate level job. This anomaly may be due to the gap between expectations, and the lack of communication prior to the hiring process. Generally, companies meet the future prospect after he has formally concluded his studies. Old solutions are staffing agencies, which may be replaced by more efficient methods of identifying talent. Current systems such as LinkedIn, for example, do not target students and do not provide verifiable and measurable information on a user. Thus, profiles in LinkedIn can not only be fake, but also completely exaggerated.

There is a gap between university preparation and employer expectations that give way to extensive training programs. Recruiting and staffing dollars are spent ineffectively by companies, and there is a need for recruiters and staffers to more effectively identify compatible candidates to help alleviate this problem. With a more efficient system, companies may be able to find the best possible fits for their companies or clients.

### SUMMARY OF THE INVENTION

This invention provides a live resume of a user by a system. A system according to an exemplary embodiment is in communication with a service provider and the user has a user profile in the system. The method includes querying the service provider for user information relating to the user. The user information is received from the service provider. The received user information is grouped into predetermined categories. Attribute scores in the predetermined categories are determined based on the grouped user information. A matrix of the attribute scores of the user is provided. The matrix represents the live resume of the user.

According to another exemplary embodiment, a live resume system is in communication with a service provider and a user. The live resume system includes a processor configured to query the service provider for user information relating to the user. The processor is further configured to receive the user information from the service provider. The processor groups received user information into predetermined categories and determines attribute scores for the predetermined categories based on the grouped user information. An interface is configured to receive the user information from the service provider, and a memory configured to store the user information and the determined attribute scores. The processor provides a matrix of the attribute scores of the user. The matrix represents the live resume of the user.

According to another exemplary embodiment, a method of providing a live resume of a first user by a system is provided. The system is in communication with a service provider, and the first user having a user profile in the system. The method includes querying the service provider for user information relating to the first user. The user information is received from the service provider. A user-fillable-form is provided to the user. Profile information is received from the first user using the user-fillable form. The received profile information is verified based on the user information from the service provider. The received user information and received profile information are grouped into predetermined categories. Attribute scores from the predetermined categories are determined based on the grouped user information and grouped profile information. A matrix of the attribute scores of the first user is provided. The matrix represents the live resume of the first user. An attribute score filter is provided and a filter selection is received. A second user is identified based on the received filter selection. A visual representation of the first user's attribute scores and a visual representation of the attribute scores of the second user are provided.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a live resume system constructed in accordance with principles of the present invention;

FIG. 2 is a block diagram of an exemplary process of providing a live resume and identifying a user in accordance with principles of the present invention;

FIG. 3 is a block diagram of an exemplary process of incorporating an aspirational user in a live resume in accordance with principles of the present invention;

FIG. 4 is an exemplary user interface in accordance with principles of the present invention;

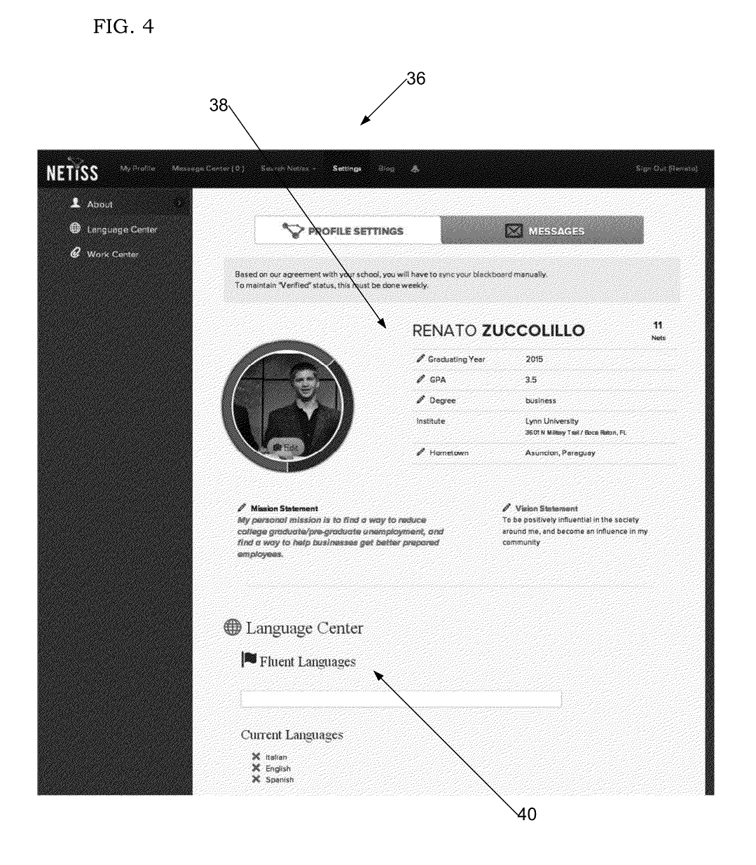

FIG. 5 is an exemplary user profile interface in accordance with principles of the present invention;

FIG. 6 is an exemplary user profile interface in accordance with principles of the present invention; and

FIG. 7 is an exemplary user profile interface in accordance with principles of the present invention.

### DETAILED DESCRIPTION OF THE INVENTION

As used herein, relational terms, such as “first” and “second,” “top” and “bottom,” and the like, may be used solely to distinguish one entity or element from another entity or element without necessarily requiring or implying any physical or logical relationship or order between such entities or elements.

In embodiments described herein, the joining term, “in communication with” and “connected to,” and the like, may be used to indicate electrical or data communication, which may be accomplished by physical contact, induction, electromagnetic radiation, radio signaling, infrared signaling or optical signaling, for example. The above methods of achieving electrical or data communication are non-limiting and mentioned only for illustration. One having ordinary skill in the art will appreciate that multiple components may interoperate and modifications and variations are possible of achieving the electrical and data communication.

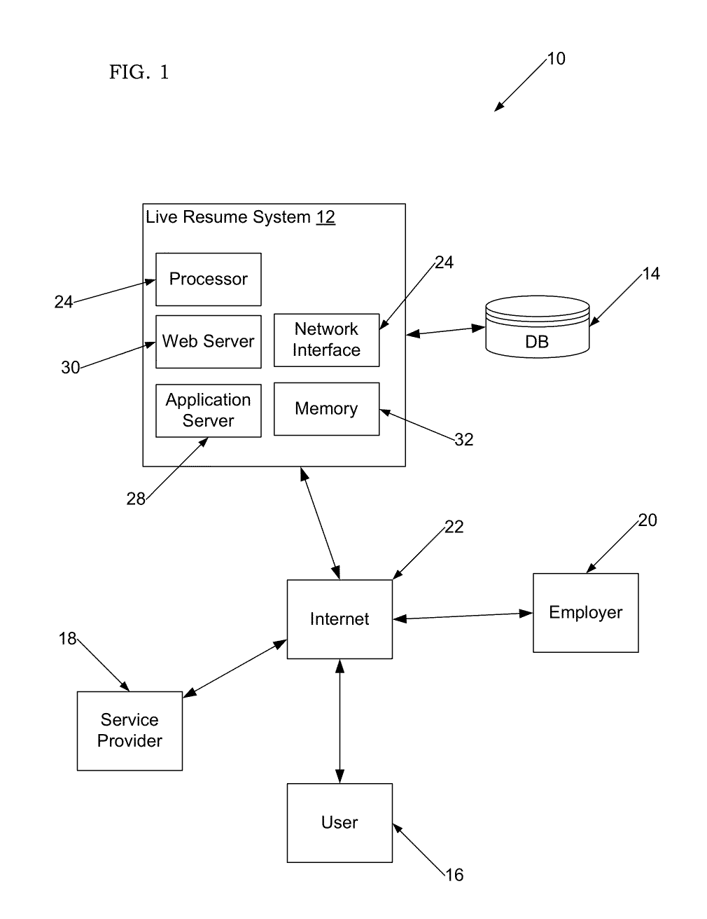

Referring to the drawings figures in which like reference designators refer to like elements, FIG. 1 shows a block diagram of a live resume system 10 according to an exemplary embodiment of the present invention. In one embodiment, system 10 is a data network. The system 10 includes a live resume server 12 in communication with a database server 14. The live resume server 12 is in communication with a user 16, service provider 18, and vendor 20 through a network 22 such as a local area network (LAN), wide area network (WAN) and the Internet.

According to exemplary embodiments, the live resume server 12 includes a processor 24 in communication with a memory 26. The live resume system 12 further includes an application server 28 and web server 30. According to some exemplary embodiments, the application server 28 and web server 30 may represent specially implemented functionality executable on a general purpose computers. In particular, application server 28 and web server 30 may be implemented in hardware on the processor 24 or as a combination of hardware and software. It will be appreciated that the web server 30 provides web content and may host a web site. The application server 28 may implement aspects of the web server 30 and/or the live resume server 12. A network interface 32, e.g., network interface card, enables the live resume system 12 to communicate over the network 22. The memory 26 includes, for example, removable and/or non-removable transitory and/or non-transitory memory and may be a database.

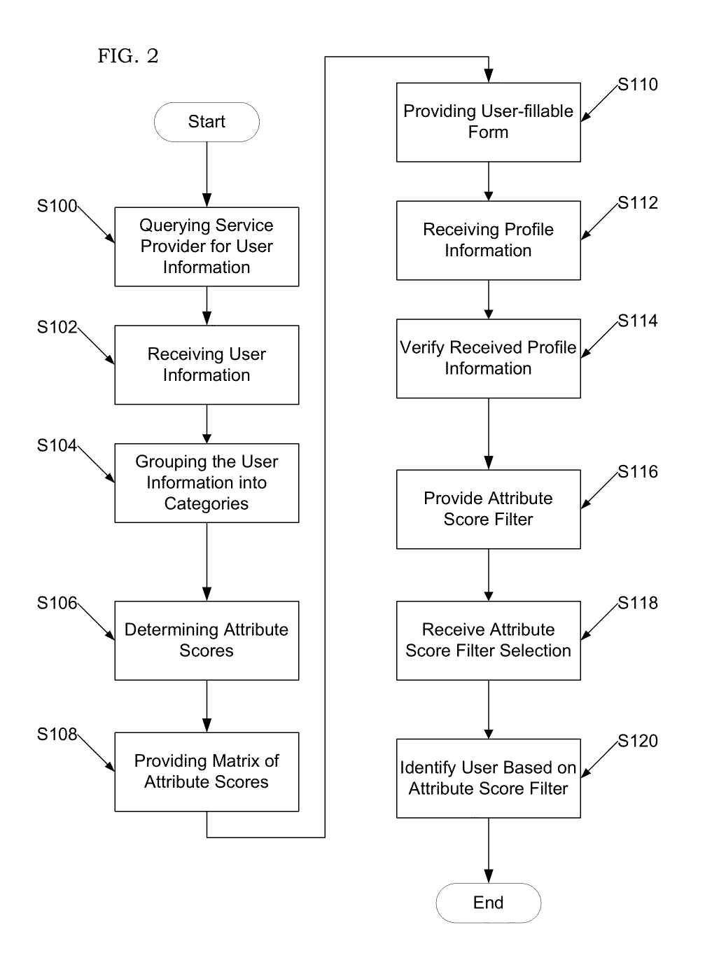

A relationship between the user 16 and vendor 20 is facilitated by the live resume server 12. According to some exemplary embodiments, the user 16 may be a student or other individual seeking employment, and the vendor 20 may be an employer. A process of providing a live resume and identifying a corresponding user is described with reference to FIG. 2. The live resume server 12 queries a service provider 18 for user information (block S100).

The service provider 18 may be an educational service, a social network, or other media service including, for example, university servers implementing Blackboard™, third party vendors, such as Karrass Negotiating™, Covey Foundation™, Sales Dogs™ or Rosetta Stone™ The live resume server 12 receives the information on a user (block S102) and groups the information into predetermined categories (block S104). The live resume server 12 determines attribute scores based on the grouped information (block S106), and provides a scoring grade matrix for the attributes (block S108). For example, the “Responsibility” attribute may include scoring grades that are determined through a combination of attendance in class, homework grades and project-on-time deliveries resulting in a score from 1-10, in which 10 is the most appealing.

According to some exemplary embodiments, the live resume server 12 may receive user information from a third party vendor, such as Karrass™, Rosetta Stone™, and social media, such as LinkedIn™, Facebook™, and Twitter™, for star skills. Star Skills are special skills that are either earned or not earned, and may not follow the 1-10 grading scale of attributes. According to other exemplary embodiments, a Language Center is created in the user's profile, which lists all the languages spoken by the user with the corresponding proof of language or verification from a service provider 18 such as, live Rossetta Stone™ scores, AP scores in High School or highest completed college course grade.

The user 16 is provided a fillable form (block S110) for completion by the user. The form data is received by the live resume server 12 (block S112) and includes user information such as the user's bio, the user's aspirations, the user' short term and long term goal. According to some exemplary embodiments, the form may include areas for entry of a personal mission and vision statement, which may be provided in separate tabs, for example, to the user 16. According to some exemplary embodiments, the user-entered form data is verified (block S114) against a third party vendor such as service provider 18.

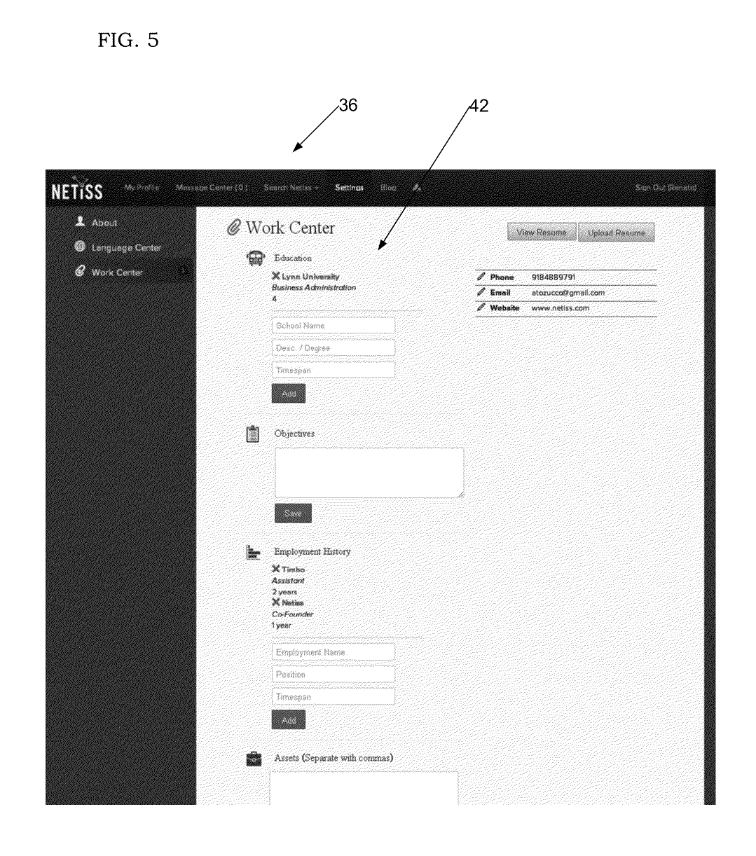

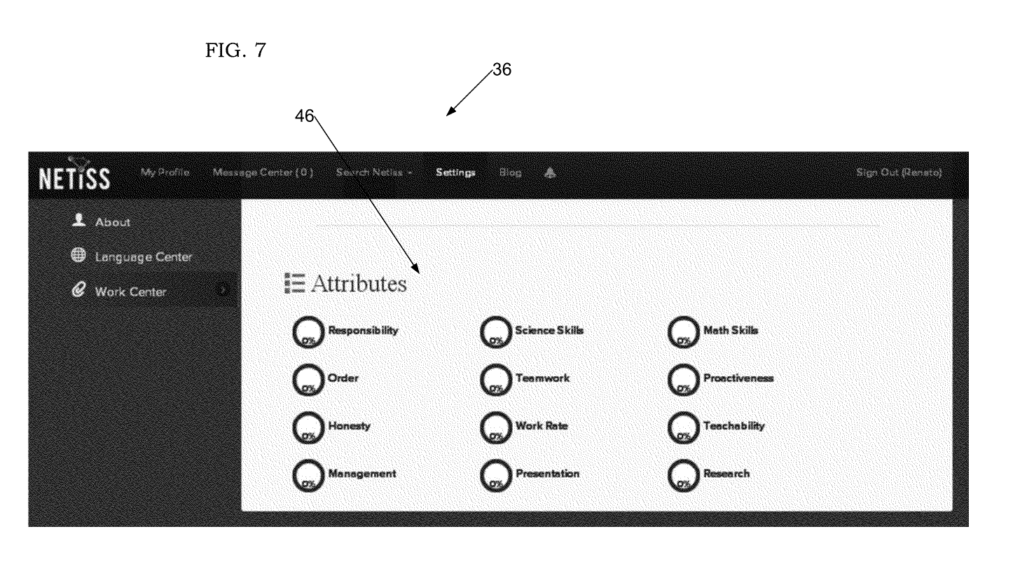

A user profile tab 36 of the live resume server 12 will now be described with reference to FIGS. 5-7. In the profile tab 36, a main profile 38 may display user profile information including, for example, the user's name, graduating year, GPA (Grade Point Average), degree attained, institute and hometown.

The live resume server 12 also includes entry of Experience and Work, which allows the user 16 to disclose, for example, images and videos of projects that he is or was participating in as well as resources, assets and a network that he has. Such information may interest a vendor 20 or fellow users 16 and generate future opportunities. The users 16 can later compare himself with other users 16, or speak with potential vendors 20 with a prospect of internships or employment. The user 16 can compare himself with the expectations of employing companies and directly interact with the vendors 20. The user 16 may utilize the live resume server 12 as a personal development tool, an online resume and a gateway to connect with vendors 20, i.e., businessmen or experts, in their respective fields. Vendors 20 would use the live resume server 12 as a tool to find better candidates for positions, and to even see if the company's core values are similar to this user's goals.

The live resume server 12 combines information from users 16 (e.g., students), vendors 20 (e.g., professors, social medias and universities as well as third party vendors) to create a main screen profile of the user 16. This main screen profile may be a replacement to inefficient staffing agencies, by allowing HR departments to do in-house scouting though searches executed on the live resume server 12. In the profile, which acts as the homepage for the user 16, the user 16 can visualize his current scores in Attributes, Skills and fluency in the Language Center 40 to view his current evaluation and access the Experience, Work Center, Dreams, Mission and Vision, Message, Personal Bio, Development Chart, Search, Compare and Increase tabs to further utilize the live resume server 12 in a development track for user's 16 aspiring to obtain future employment or personal growth.

The live resume server 12 may include an Increase tab, which is the tool for a user 16 who desires to gain a skill, fluency in a language or attribute or one who is concerned by a drop in any of the three measures. The Increase tab may allow the user 16 to select, for example, any of the 12 Attributes, 8 Skills or any language and view Influences and Increases. Influences are what factors are currently affecting the measure with a (+) if positive and a (−) if negative. The Increase tab also includes a list of unaccomplished objectives that would raise the measure of a skill or a category to a desired level. According to some exemplary embodiments, an HR Department can suggest student specific measures for increase and this is how the live resume server 12 would provide awareness for the student on Do's and Don'ts.

The user profile tab 36 of the live resume server 12 includes an Experience section 42 that enables the user 16 to provide potential employers a list of charity, work, and other meaningful experiences the user 16 has lived with a gallery of photos and videos from YouTube™, Facebook™, and any other source that may prove the experience. The user 16 also lists the experiences and the type of experience so a hiring company can also filter a search by students who have the specific experience. As part of our expansion strategy, the experiences would be mostly verified by the employers and organizations, but initially it will be student input.

The live resume server 12 includes an Work Center that consists of a tool for user 16 having an entrepreneurial vision who look to invest assets, connections or resources in an effort to gain financial benefits through partnering with vendor 20 or other users 16 with similar interests that can contribute to the creative venture. A user 16 may lock or unlock this tab since it contains information some deem sensitive. Some users 16, however, may list cash, liquid assets and long term assets, the key mentors or partners they have access to, and the patents, access to capital or any other resource they could provide in working together.

The live resume server 12 includes a Personal Bio Tab for the user 16 to write an essay that describes himself as a person and any other information he believes a vendor 20 or partner should know about him.

The live resume server 12 includes a Dreams Tab, which reflects the user's dreams or aspirations, which may be separated in: dream character and specific dreams. The dream character is the person or user the user 16 most aspires to emulate (aspirational user). According to some exemplary embodiments, the live resume server 12 may suggest an aspirational user. The dreams tab may include a chart with major milestones, e.g., 4 or 5 milestones, that a person moving in the direction of the dream character should accomplish, for example, by his graduation from college. For this example, this could include: publish a book with 10,000+ sales, receive a degree in Education, tutor 10 courses throughout college and graduate with honors. Although the aspirational user may not have necessarily taken these steps in college or at any point in his life, the steps prove the user's 16 growth toward emulating the aspirational user because the major goals may be significant to the user's 16 dream profession. The Specific dream may include a listing of the user's specific dreams, which may be of a personal, business, science, art or engineering nature. This information may serve as both a compass for growth for a user 16 and a map of orientation for a vendor 20 to understand the aspirations of the user 16. Sample dreams include, for example, to become president, serve in the military, patent an invention, win a Nobel prize, etc.

The live resume server 12 includes a Mission and Vision Tab in which the user 16 write a personal and professional mission and vision statement which serves a similar purpose to the dream tab but with respect to guiding principles. The tab would display and enable the user 16 to edit this information.

The live resume server 12 includes a search tab, which includes a search bar that allows the user 16 to visualize other users 16 and vendors 20 (e.g., students, universities, employers or strategic partners) to establish communication or simply view information in their profiles. Users 16 and vendors 20 may filter searches (block S116) by attribute scores or attributes including, for example, company, university, class, major, GPA (Grade Point Average), age, attribute, skill, language, dream character, preferred area of work or even overall potential (block S118). The search results are shown to the user 16 (block S120) in the search tab.

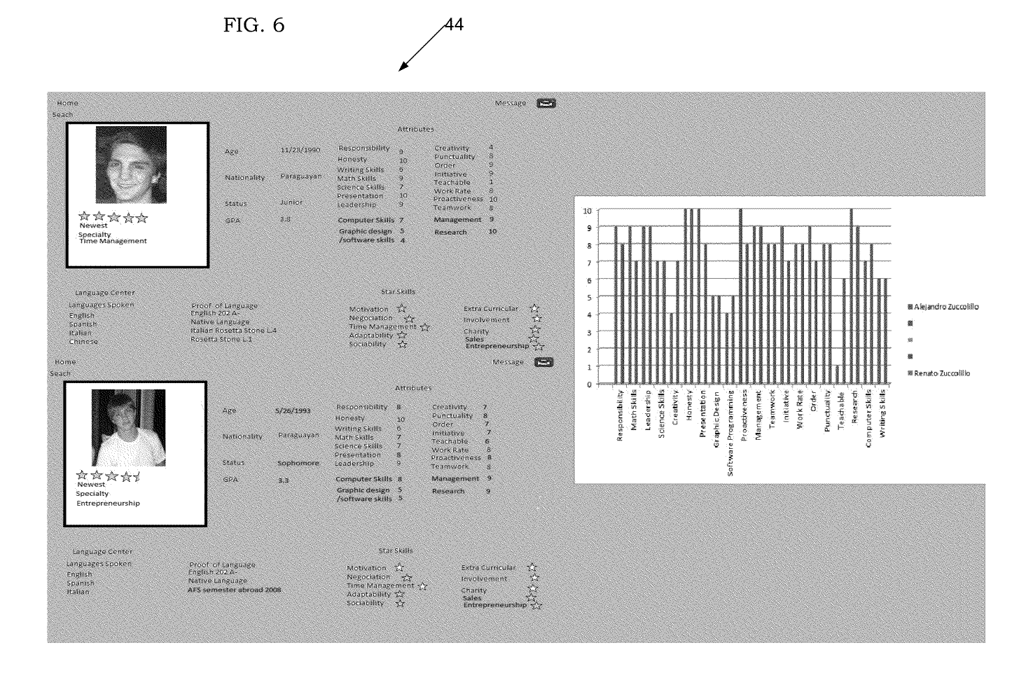

The live resume server 12 includes a compare tab 44, which is now described with reference to FIG. 6. In the compare tab 44, a user 16 may view two or more user profiles at the same time and select which one is more desirable for mentorship, interview, internship or employment. The compare tab 44 may show the profiles in a single screen and a graph, e.g., bar graph, for comparing both users 16 or vendors 20. The compare tab 44 may be utilized mostly by vendors 20 but may also be used by a university, for example, who desires to scout a talented user 16 for transfer.

The live resume server 12 includes a development chart tab, which includes a tool for a user 16 to view his progression over time to his current date. The development chart tab may display a line graph for all attributes and icons for every skill, language or milestone achieved. Users 16 may select or unselect measures to show or hide attributes from the graph to suit their desires.

Embodiments of this invention may be applied through online educational channels, e.g., university channels, who may charge a fee per subscribed user. User profiles would be self-created, but the information would be verified by the University admissions office, the University's system (e.g., admissions office, Registrar), professors and by the grading system that the professors use. It will be appreciated that the grading system may use, but are not limited to, combinations of attendance, punctuality, group projects, individual works, tests and even homework as well as participation in programs, presentations, student council, filing of patents. The three categories of input from the online educational channel include, for example, university input directly pulled from Blackboard™ or a similar interface, professor input through short questions about a student, and strategic allies with input in courses not offered by the curricula. The live resume server 12 may revise scores periodically to insure the latest content is considered in every measurement.

The live resume server 12 may use an online interface or webpage, i.e., Graphical User Interface (GUI). Access to the online interfaces and delivery of content may be controlled.

The live resume server 12 obtains attribute information directly from the service provider 18, e.g., the university platform such as BlackBoard™ or Moodle™, which are the main course management systems. Specifically for the first projects Blackboard 9.1 and create a matrix using the information input from the university professors and classes. Each attribute uses different matrix based on different mixes that will reflect the quality the student currently possesses in each attribute. The attributes are live and constantly changing according to the current performance of a student, yet are recorded in the development chart that can be viewed by employers and fellow students to compare growth and attributes.

Star Skill information is based on courses taken outside the service provider 18, i.e., the university. These courses would be uploaded by a strategic ally such as Karass™ for Negotiating, Corey Foundation™ for Proactiveness, etc. Each star skill will be listed in a separate page with information on how to acquire a skill as well as how to lose it. These skills may not be graded 1-10 like the attributes based on Blackboard™ input, but simply uploaded by the strategic ally, resulting in a star in the user 16 profile if completed and an empty star if not completed.

The live resume server 12 calculates attributes scores by apportioning the user information. The attribute scores may be shown in the user profile tab 36 in an attributes section 46. For example, the attribute scores for the scoring matrix may be apportions as:

Responsibility: 40% average homework grade,
40% timely delivery of projects and papers, and
20% attendance in class.
   Leadership measured by: 30% class participation,
30% group projects,
25% significant student involvement, ex. student government, and
10% external leadership courses.
   Creativity: 30% art skills,
10% marketing & advertising innovation,
25% professor evaluation,
35% creativity test, and
+2 per patent.
   Work Date: 40% amount of courses taken,
35% GPA of courses taken, and
25% extracurricular activities.
   Teachable: 50% teacher input,
30% GPA,
10% amount of languages spoken, and
10% level of language comprehension.
   Writing Skills: 85% average of written assignments, and
+15% score for personal bio essay (graded by a professor).
   Math skills: 80% level of math passed, and
20% GPA in math courses.
   Management: 40% average project grade,
20% GPA,
+25% bonus per management course in university, and
+1 if honors.
   Order: Can upload photo or video 5 second clip of dorm room for +2 points, and
Average homework grade.
   Team work: Average group project grade, and
+1 point student council
   Research: Average of research paper+project, and
+4 points for a patent.
   Presentation: Average of university presentation projects, and
+1 per 5 public speaking course hours in the year.
   Computer skills: average of Computer and Information Science (CIS) grades, and
+2 for software patent.

### Proactiveness: Average GPA,

+1 per verifiable extracurricular,
+1 per charity actively involved,
+3 patent, and
+1 if honors student

### Leadership: Average of GPA,

+2 if student council, and
+1 if honors student

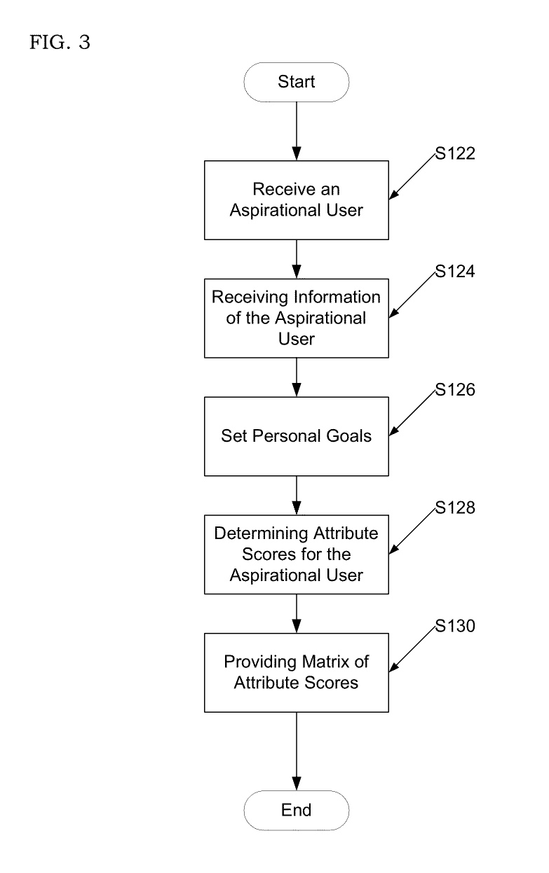

The live resume server 12 includes a Dream Character Specific Interface, which is described with reference to FIG. 3. The Dream Character Specific Interface gives a user 16 an opportunity to explore their dreams and set a character they aspire to minor. First, the student selects a dream character (block S122). The student can then receive dreams related to this character (block S124) with the goal of emulating the dream character. The user may set personal goals based on the dream character (block S126) such as running a marathon, working in a specific company, having a family, reducing poverty, or reforming the educational system, for example. A personal dream relating to business, science, art or engineering could include one day working at Google™ and obtaining a patent, selling a masterpiece, or making the largest shopping mall in the world, for example. According to some exemplary embodiments, attribute scores may be determined for the dream character (block S128) and a matrix of attribute scores of the dream character may be provided (block S130).

The experience section 42 enables a user 16 to provide potential employers a list of charity, work, and other meaningful experiences the user 16 has experienced. The experience section 42 may include a gallery of photos and videos from YouTube™, Facebook™ or any other source that prove the experience. For example, the user 16 may indicate participating in a 3-month Education Community Service program. The user 16 may list the program in his experience section 42, describe the type of service; and add photos and videos, which may make the user's 16 experience more relevant for employers looking for students who give back to society.

The live resume server 12 includes a Language, Skill and Attribute Increase tab. The user 16 may utilize this tab to access specific positive or negative influences in their attributes, language center, or star skills and advise to increase it. The influences are classified as current and past influences that are for current semester and previous college semesters. The user 16 may work on improving the influences both past and current that lower or maintain any skill, attribute or language at a constant to increase the interest of a vendor 20. The vendor's subscription to the live resume server 12 can be tailored to receive notifications when a user 16 increases a skill, attribute, language level or specific milestone for offering employment, approval of aid, internship or interview opportunities to provide incentive for the student's development.

The profile tab 36 of the live resume server 12 includes a Language Center 40. The language center 40 permits user 16 to input his spoken and/or written language, which is backed by a proof of language section. The proof of language includes credentials from both university courses as well as strategic allies such as Rosetta Stone™ which will upload updated information on each language with the score and level of fluency the user 16 has currently demonstrated. According to some exemplary embodiments, this section may update every time a student advances in either program to fluency.

The live resume server 12 includes a mission and vision statements page, which allows the users 16 to provide their beliefs. A user has both a personal and a professional mission and vision to show future employers what they are seeking and their passions. The mission and visions statements page may preemptively resolve disparities between the vendor's 20 expectations about personal matters before hiring users 16.

The live resume server 12 includes Search Bar Information, which is an advanced search bar. In the Search Bar Information, vendors 20 could search for users 16 based on the user's attributes. Vendors 20 would be able to seek out specific attributes that they are drawn to, and narrow down their search. Vendors 20 could search universities by location or by specific names. Vendors 20 could also search by specific names or by their nationalities. Vendors 20 may also search students having specific attributes, e.g., star skills, or through other filters.

Star Skill Specifics:

Motivation: At least one approved motivation course: per 1.5 years in college to receive star.
Sociability: Based on a ratio of the number of friends a user 16 has on LinkedIn™, Facebook™ or Twitter to the number of connections the user has in the live resume server determines the number of stars awarded.
Negotiation: At least one approved negotiation course per 1.5 years in the university for star.
Adaptability: User 16 must have: 1 year abroad, speak 2 languages past 50% development (must have both for star).
Time Management: Top 15th percentile of class in homework average to have star.
Involvement: A user 16 must be actively participating in 2 university groups for a star.
Sales: User 16 must have one salesman or sales representative internship for every 2 years for star.
Entrepreneurship: Company reaches break even in college incubator or earns $10,000 profit if started prior to university studies for a star.
Charity: User 16 has X many hours of community service that is verifiable (expand to make service verifiable) for a star.
Extracurricular: User 16 must play a sport, perform for a band/orchestra, student government or student association (must have 2 of 4 for star).

The Development Chart described above is a tool for users 16 (students), service providers 18 (universities) and vendors 20 (alumni/employers) who track the development of a specific student and project the student 2, 3 years into the future to determine if he is desirable for cooperation, hiring or transfer to a different university. The Development chart contains a silhouette that is filled out to the level of your current ability to represent your current growth. The silhouette may be a silhouette of the selected aspirational user. The silhouette may be an image, cartoon or avatar of an actual inspirational character. Each attribute, skill and language can be selected separately or together to view a chart of the development through college and icons appear when a new skill or language fluency is achieved. A different icon appears when a landmark goal is achieved and the student has received their desired objective in terms of either of the 3 measurements.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of providing a live resume of a user by a system, the system being in communication with a service provider, the user having a user profile in the system, the method comprising:
querying the service provider for user information relating to the user;
receiving the user information from the service provider;
grouping the received user information into predetermined categories;
determining attribute scores in the predetermined categories based on the grouped user information; and
providing a matrix of the attribute scores of the user, the matrix representing the live resume of the user.

2. The method of claim 1, further comprising:
providing an attribute score filter;
receiving a filter selection; and
identifying a second user based on the received filter selection.

3. The method of claim 2, further comprising:
identifying a third user based on the received filter selection; and
providing a second matrix of the second user and a third matrix of the third user.

4. The method of claim 3, further comprising:
providing a visual representation of the second user's attribute scores and a visual representation of the attribute scores of the third user, wherein the visual representations include at least one of a histogram, a line graph, a bar graph, and a pie chart.

5. The method of claim 1, further comprising:
determining a star skill of the user based on information from a first service provider; and
verifying the star skill based on information from a second service provider.

6. The method of claim 1, further comprising:
providing a user-fillable-form;
receiving profile information from the user using the user-fillable form; and
verifying the received profile information based on the user information from the service provider.

7. The method of claim 1, further comprising:
receiving an aspirational user profile from the user; and
presenting the attribute scores of the user relative to the attribute scores of the aspirational user.

8. The method of claim 7, further comprising:
identifying an improvement category of the user, the improvement category being one of the predetermined categories the user's attribute score is less than at least one of the attribute score of the aspirational user and an attribute score of an average user profile.

9. The method of claim 7, further comprising:
receiving information of the aspirational user profile from the service provider;
grouping the received aspirational user information into the predetermined categories; and
determining attribute scores for the predetermined categories based on the grouped aspirational user information.

10. A live resume system, the live resume system in communication with a service provider and a user, the live resume system comprising:
a processor configured to:
query the service provider for user information relating to the user;
receive the user information from the service provider;
group received user information into predetermined categories;
determine attribute scores for the predetermined categories based on the grouped user information; and
provide a matrix of the attribute scores of the user, the matrix representing the live resume of the user; and
an interface configured to receive the user information from the service provider; and
a memory configured to store the user information and the determined attribute scores.

11. The system of claim 10, wherein the processor is further configured to:
provide an attribute score filter;
receive, by the interface, a filter selection; and identify a second user based on the received trades; and
identify a second user based on the received filter selection.

12. The system of claim 11, wherein the processor is further configured to:
identify a third user based on the received filter selection; and
provide a second matrix of the second user and a third matrix of the third user;

13. The system of claim 12, wherein the processor is further configured to:
provide a visual representation of the attribute scores of the second user and a visual representation of the attribute scores of the third user, wherein the visual representations include at least one of a histogram, a line graph, a bar graph, and a pie chart.

14. The system of claim 10, wherein the processor is further configured to:
determine a star skill of the user based on information from a first service provider; and
verify the star skill based on information from a second service provider.

15. The system of claim 10, wherein the processor is further configured to:
provide a user-fillable form; and
verify profile information, which is received by the interface, based on the user information from the service provider.

16. The system of claim 10,
wherein the interface is further configured to receive an aspirational user profile from the user; and
wherein the processor is further configured to the attribute scores of the user relative to the attribute scores of the aspirational user.

17. A method of providing a live resume of a first user by a system, the system being in communication with a service provider, the first user having a user profile in the system, the method comprising:
querying the service provider for user information relating to the first user;
receiving the user information from the service provider;
providing a user-fillable-form;
receiving profile information from the first user using the user-fillable form;
verifying the received profile information based on the user information from the service provider;
grouping the received user information and received profile information into predetermined categories;
determining attribute scores in the predetermined categories based on the grouped user information and grouped profile information;
providing a matrix of the attribute scores of the first user, the matrix representing the live resume of the first user;
providing an attribute score filter;
receiving a filter selection; and
identifying a second user based on the received filter selection; and
providing a visual representation of the first user's attribute scores and a visual representation of the attribute scores of the second user.

18. The method of claim 17,
wherein the visual representations include at least one of a histogram, a line graph, a bar graph, and a pie chart.

19. The method of claim 17, further comprising:
receiving an aspirational user profile from the first user;
receiving information of the aspirational user profile from the service provider;
grouping the received aspirational user information into the predetermined categories; and
determining attribute scores for the predetermined categories based on the grouped aspirational user information;
identifying an improvement category of the user, the improvement category being one of the predetermined categories the user's attribute score is less than the aspirational user profile's attribute score; and
presenting the user's attribute scores relative to the aspirational user profile's attribute scores.

20. The system of claim 17, wherein the service provider is one of a social networking, a search engine, and an online learning platform.
